(19) United States
(12) Patent Application Publication
(10) Pub. No.: US 2014/0217211 A1
(43) Pub. Date: Aug. 7, 2014

(54) Kitchan Appliance With Quiet Shield and Method of Operating Same

(71) Applicant: HAMILTON BEACH BRANDS, INC., Glen Allen, VA (US)

(72) Inventor: Michael G. Sanford, Mechanicsville, VA (US)

(73) Assignee: HAMILTON BEACH BRANDS, INC., Glen Allen, VA (US)

(21) Appl. No.: 13/758,462

(22) Filed: Feb. 4, 2013

(51) Int. Cl. A47J 43/07

(52) U.S. Cl. CPC A47J 43/0761
USPC 241/37.5; 241/100

(57) ABSTRACT

A kitchen appliance includes a base having a top wall and a motor. A container is removably mountable to the base. At least a portion of the container is operatively engaged with the motor to prepare foodstuff therein. A shield is removably mountable onto the base to enclose the container. At least one locking mechanism secures at least a portion of the shield to the base. The locking mechanism includes a projection formed on or in one of the base and the shield and a locking tab attached to the other of the shield and the base. The locking tab is slidable between a first position and a second position. In the first position, the locking tab is spaced-apart from the projection. In the second position, at least a portion of the locking tab engages at least a portion of the projection.

### SUMMARY OF THE DISCLOSURE

The present disclosure relates generally to a kitchen appliance for preparing foodstuff. In one embodiment, the subject kitchen appliance includes a quiet shield that is removably mountable onto and attachable to a base of the kitchen appliance.

### BACKGROUND OF THE DISCLOSURE

Kitchen appliances for preparing foodstuff are well known. Certain conventional kitchen appliances include a cover or shield that surrounds a portion of the kitchen appliance. Such covers generally reduce noise emitted by the kitchen appliance, as well as help to confine foodstuff that may be inadvertently ejected, spilled or otherwise released from a portion of the kitchen appliance.

It has heretofore not been discovered how to create a kitchen appliance that includes a quiet shield that is quickly and easily mountable onto and detachable from another portion of the kitchen appliance. The device of the following disclosure accomplishes the above and other objectives and overcomes at least the above-described disadvantage of conventional kitchen appliances.

### BRIEF SUMMARY OF THE DISCLOSURE

Briefly stated, one aspect of the present disclosure is directed to a kitchen appliance including a base having a top wall and a motor positioned beneath the top wall. A container is removably mountable to the top wall of the base. At least a portion of the container is operatively engaged with the motor to prepare foodstuff therein. A shield is removably mountable onto the base to enclose the container. At least one locking mechanism secures at least a portion of the shield to the base. The locking mechanism includes a projection formed on or in one of the base and the shield and a locking tab attached to the other of the shield and the base. The locking tab is slidable between a first position and a second position. In the first position, the locking tab is spaced-apart from the projection to allow the shield to be removed from the base. In the second position, at least a portion of the locking tab engages at least a portion of the projection to secure the shield to the base.

In another aspect, the present disclosure is directed to a kitchen appliance including a base having a top wall and a motor positioned beneath the top wall. A container is removably mountable to the top wall of the base. At least a portion of the container is operatively engaged with the motor to prepare foodstuff therein. A shield is removably mountable onto the base to enclose the container. At least one locking mechanism secures at least a portion of the shield to the base. The locking mechanism includes a groove formed on or in one of the base and the shield and a locking tab attached to the other of the shield and the base. The locking tab is movable between a first position and a second position. In the first position, at least a portion of the locking tab is aligned with a passageway of the groove to allow the shield to be removed from the base. In the second position, at least a portion of the locking tab is spaced-apart from the passageway to secure the shield to the base.

### BRIEF DESCRIPTION OF THE SEVERAL VIEWS OF THE DRAWINGS

The foregoing summary, as well as the following detailed description of the disclosure, will be better understood when read in conjunction with the appended drawings. For the purpose of illustrating the disclosure, there are shown in the drawings an embodiment which is presently preferred. It should be understood, however, that the disclosure is not limited to the precise arrangements and instrumentalities shown. In the drawings:

FIG. 1 is a perspective view of a kitchen appliance according to an embodiment of the present disclosure, wherein a shield of the kitchen appliance is shown in a closed position;

FIG. 2 is another perspective view of the kitchen appliance shown in FIG. 1, wherein a portion of the shield is shown in an open position;

FIG. 3 is a bottom perspective view of the shield and locking mechanisms of the kitchen appliance shown in FIG. 1;

FIG. 4 is a enlarged partial perspective view of a portion of the kitchen appliance shown in FIG. 1, wherein a portion of the shield is omitted for clarity; and

FIG. 5 is another enlarged partial perspective view of a portion of the kitchen appliance shown in FIG. 1, wherein a portion of the shield is omitted for clarity.

### DETAILED DESCRIPTION OF THE DISCLOSURE

Certain terminology is used in the following description for convenience only and is not limiting. The words “lower,” “bottom,” “upper” and “top” designate directions in the drawings to which reference is made. The words “inwardly,” “outwardly,” “forward,” “rearward,” “upwardly” and “downwardly” refer to directions toward and away from, respectively, the geometric center of the device, and designated parts thereof, in accordance with the present disclosure. Unless specifically set forth herein, the terms “a,” “an” and “the” are not limited to one element, but instead should be read as meaning “at least one.” The terminology includes the words noted above, derivatives thereof and words of similar import.

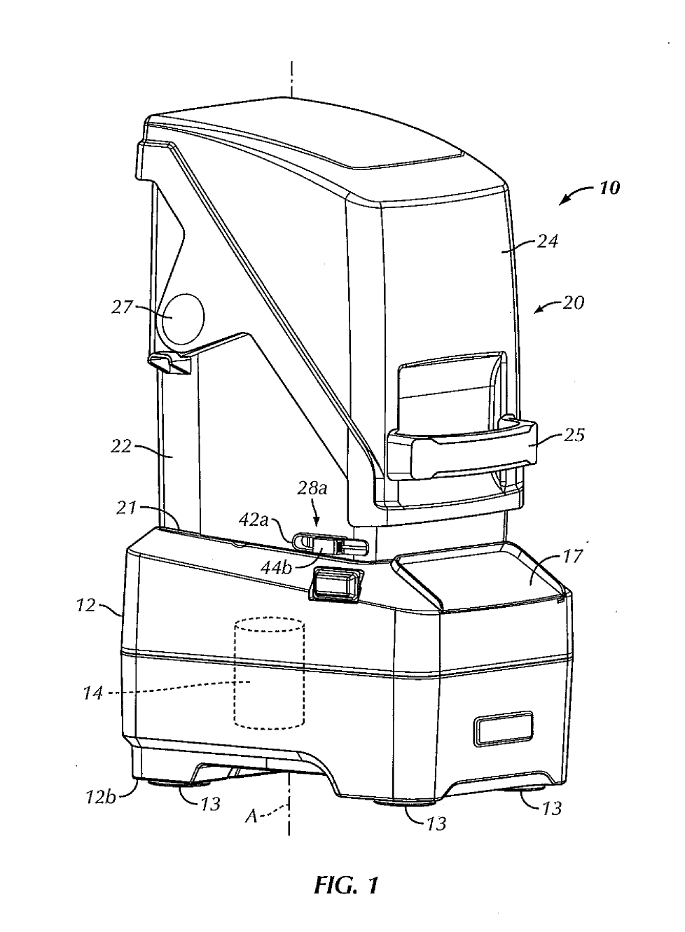

Referring to the drawings in detail, wherein like numerals indicate like elements throughout, FIGS. 1-5 illustrate a kitchen appliance, generally designated 10, in accordance with an embodiment of the present disclosure. The kitchen appliance 10 is preferably a blender, a food processor, a food chopper, a grinder or another mixing device, but the present invention is not so limited. For example, the kitchen appliance 10 may any other device in which it is desirable to cover or encloses at least a portion of the kitchen appliance 10 to at least reduce any noise produced during operation and/or confine at least a portion of the kitchen appliance 10, such as for containing inadvertently ejected or released foodstuff. The term “foodstuff,” as used herein, is sufficiently broad to cover any liquid, semi-solid or solid edible substance that is capable of being consumed and/or digested by a user, such as ice cream, fruit, vegetables, coffee grounds, tea leaves, hot chocolate powder, soup ingredients, oatmeal and the like.

Referring to FIGS. 1-5, the kitchen appliance 10 preferably includes a base 12 enclosing the motor 14 (shown schematically in broken lines in FIG. 1). The base 12 includes a generally flat or planar top wall 12a and an opposing bottom wall 12b. A control panel 17, having one or more buttons (none shown), is preferably positioned proximate a front and the top wall 12a of the base 12. The bottom wall 12b may include one or more feet 13 (see FIG. 1) that extend downwardly therefrom. The feet 13 or the bottom wall 12b of the base 12 preferably rests directly on a support surface (not shown), such as a table top or countertop, when the kitchen appliance 10 is in use. The motor 14 is preferably at least generally surrounded by the base 12 and positioned beneath the top wall 12a thereof. A fan (not shown) may also be positioned within the base 12 to dissipate heat generated by the motor 14.

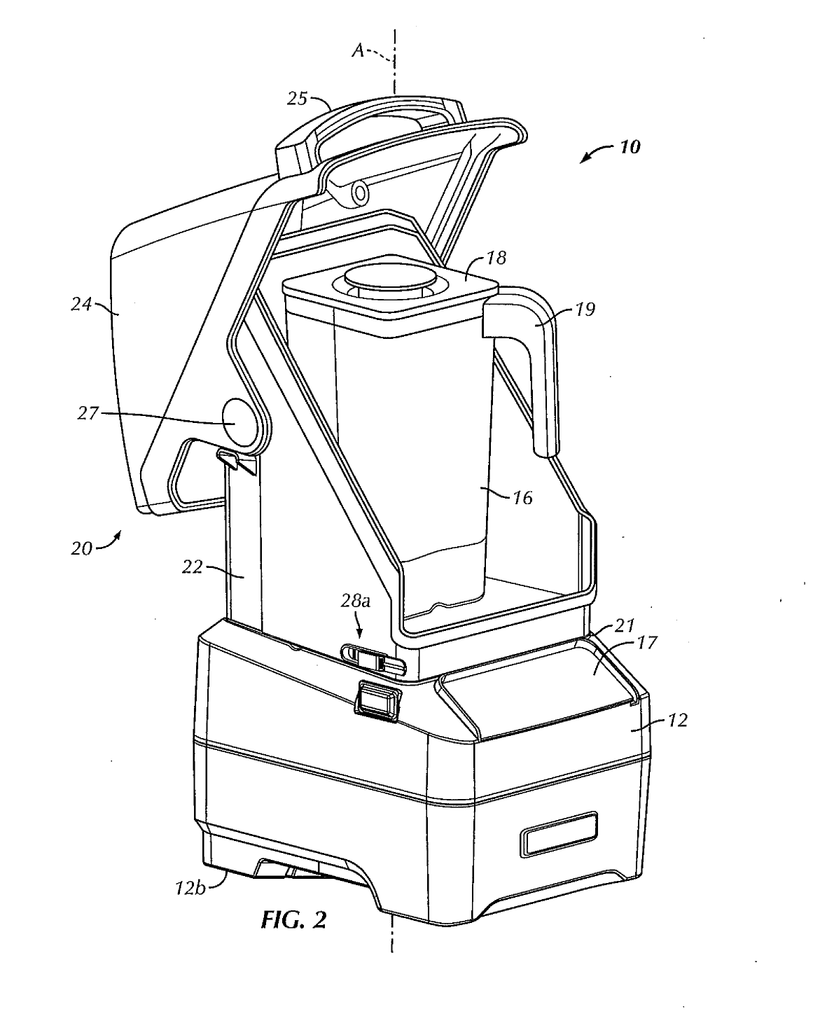

As shown in FIGS. 2, 4 and 5, a container or jar 16 for holding foodstuff (not shown) to be blended, processed and/or chopped is preferably removably mountable onto the top surface 12a of the base 12. The jar 16 may include a collar (not shown) that is removably mountable directly to the base 12. A removable or permanent pad 15 may be placed on top of the top wall 12a of the base 12 and beneath the jar 16. The pad 15 may be formed of a polymeric material and is preferably generally co-extensive with the top wall 12a of the base 12a. A lid 18 (see FIG. 2) is preferably removably mounted to an upper opening of the jar 16 to enclose the foodstuff therein. A handle 19 preferably extends outwardly from the jar 16. At least a portion of the jar 16, such as an internal blade (not shown), is operatively connected to the motor 14 to blend, process and/or chop foodstuff within the jar 16. A clutch mechanism (not shown) may be used to operatively connect the jar 16 to the motor 14 in a manner well understood by those of ordinary skill in the art.

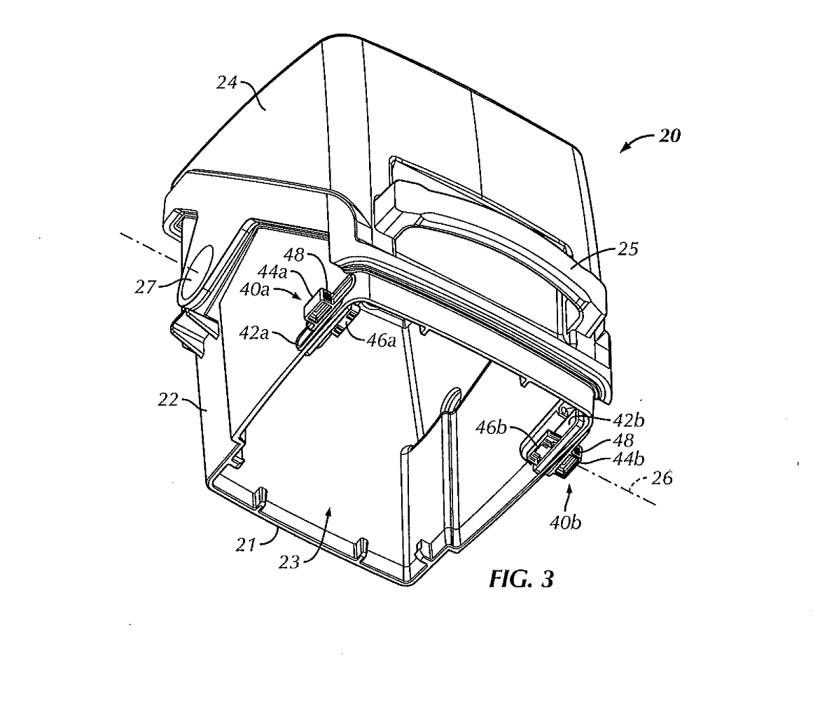

Referring to FIGS. 1-3, the kitchen appliance 10 includes an enclosure or quiet shield 20 removably mountable onto at least a portion of the base 12. At least a portion of the shield 20 is preferably configured to be attached, fixed and/or locked to the base 12 proximate the top wall 12a thereof. The shield 20 is sufficiently sized, shaped and/or configured to surround the jar 16 and enclose the jar 16 with the top wall 12a of the base 12 when the shield 20 is properly attached to the base 12. As shown in FIG. 3, a lower edge 21 of the shield 20 preferably defines an opening 23 that is preferably at least slightly larger than an outer periphery of the top wall 12a of the base 12, so that at least a portion of the shield 20 can surround and/or complement at least a portion of the base 12. The shield 20 is preferably formed of a transparent or translucent material, such as a high-strength, light-weight polymeric material, so that the jar 16 is visible to a user even when the shield 20 is mounted onto the base 12 and in a closed position (described in detail below). Alternatively, the shield 20 may be opaque.

As shown in FIGS. 1-3, the shield 20 preferably includes a first or fixed portion 22 and complementary second or movable lid portion 24. The fixed portion 22 is attachable to the base 12 proximate the top wall 12a thereof. When properly attached to the base 12, the fixed portion 22 is preferably non-movable with respect to the base 12. The movable lid portion 24 is pivotably attached to the fixed portion 22 by a pair of hinges 27 (only one shown in FIGS. 1-3) about an axis 26 (see FIG. 3) that preferably extends generally, if not exactly, parallel to the top wall 12a of the base 12 when the shield 20 is properly mounted onto the base 12. The axis 26 is preferably positioned proximate a rear of the kitchen appliance 10 and/or the base 12 when the shield 20 is properly attached to the base 12.

The movable lid portion 24 is preferably pivotable between a first, open position (see FIG. 2) and a second, closed position (see FIG. 1). In the first position (FIG. 2), the movable lid portion 24 exposes an interior of the shield 20, such as the jar 16, to the external environment. In the second position (FIG. 1), the movable lid portion 24 and the fixed portion 22 combine to enclose the interior of the shield 20. The movable lid portion 24 preferably includes a handle 25 proximate a front of the kitchen appliance 10 and/or base 12 to allow a user to more easily lift and/or rotate the movable lid portion 24 between the first and second positions. Each of the first portion 22 and the movable lid portion 24 generally forms half of the enclosure that constitutes the internal cavity of the shield 20.

Referring to FIGS. 1-5, the kitchen appliance 10 includes at least one and preferably two or more spaced-apart and independent locking mechanisms 28a, 28b. The locking mechanisms 28a, 28b permit at least a portion of the shield 20 to be selectively locked and unlocked with respect to the base 12. The locking mechanisms 28a, 28b are preferably formed on opposing sides of the kitchen appliance 10. Each locking mechanism 28a, 28b is preferably positioned proximate the front of the kitchen appliance 10 and/or the base 12. Such a location of the locking mechanisms 28a, 28b helps to keep the shield 20 balanced when the movable lid portion 24 is moved to or positioned at the first position (see FIG. 2). More specifically, when the movable lid portion 24 is fully opened, a center of gravity of the shield 20 is located behind the rear or back of the kitchen appliance 10. Positioning the locking mechanisms 28a, 28b at or toward the front of the kitchen appliance 10 counterbalances or resists the weight shift, and increases the stability of the shield 20 on the base 12.

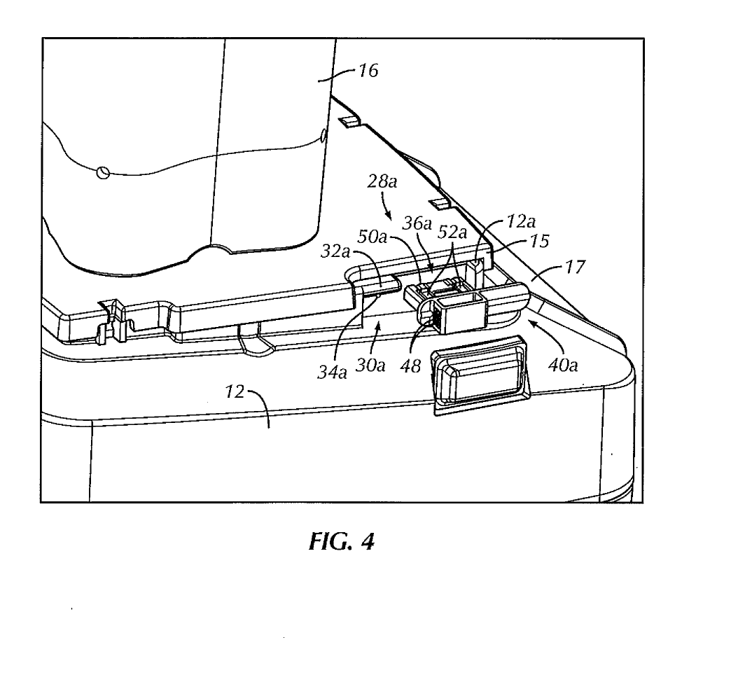

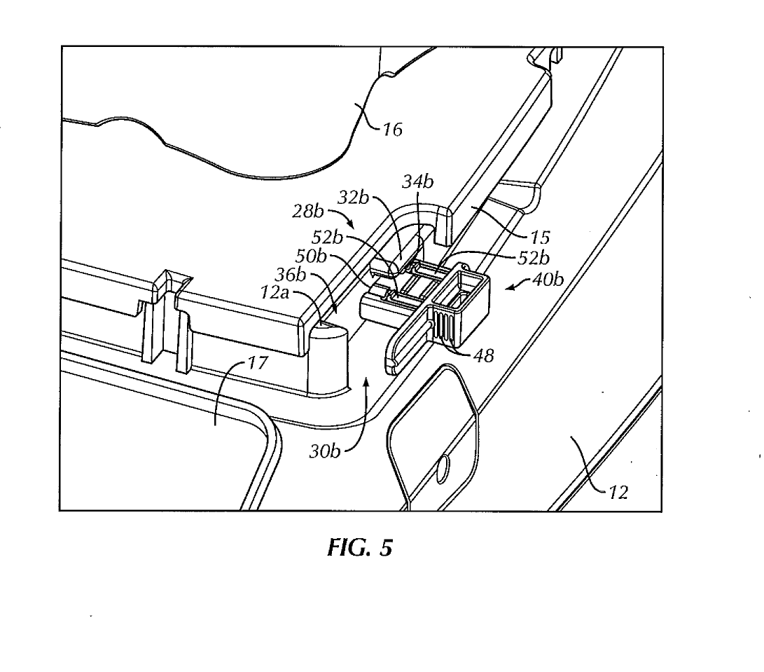

Referring to FIGS. 4 and 5, each locking mechanism 28a, 28b includes a groove or recess 30a, 30b, respectively, formed in one of the base 12 and the shield 20. In other words, two spaced-apart grooves 30a, 30b are formed in one of the base 12 and the shield 20. As shown in FIGS. 4 and 5, each groove 30a, 30b is preferably positioned proximate to or immediately below the top wall 12a of the base 12 and extends laterally inwardly into an interior of the base 12. A ledge 32a, 32b, which may be an extension of the top wall 12a of the base 12, preferably surrounds at least a portion of each groove 30a, 30b, respectively. At least one protrusion 34a, 34b extends at least slightly downwardly from each ledge 32a, 32b, respectively, and at least slightly into the respective groove 30a, 30b. Each protrusion 34a, 34b may have a generally cylindrical shape, but the protrusions 34a, 34b are not limited to any particular size, shape and/or configuration.

Referring to FIGS. 1-5, each locking mechanism 28a, 28b includes a locking tab 40a, 40b, respectively, formed in one of the shield 20 and the base 12. In other words, two spaced-apart locking tabs 40a, 40b are formed in one of the shield 40 and the base 12. As shown in FIGS. 1-3, each locking tab 40a, 40b is preferably positioned proximate to or immediately above lower edge 21 of the shield 20. As shown in FIG. 3, opposing sidewalls of the fixed portion 22 of the shield 20 each include a slot 42a, 42b, which receives and engages one of the locking tabs 40a, 40b. Each slot 42a, 42b preferably has a generally rectangular or ovular shape, and extends generally, if not exactly, perpendicularly to the axis 26 and a longitudinal axis A (see FIGS. 1 and 2) of the kitchen appliance 10. Each locking tab 40a, 40b extends through the respective slot 42a, 42b.

As shown in FIG. 3, an outer portion 44a, 44b of each locking tab 40a, 40b extends laterally outwardly beyond an exterior surface of the shield 20. The outer portion 44a, 44b of each locking tab 40a, 40b provides a surface or handle for a user to grasp so as to manually move or slide the locking tabs 40a, 40b, as described in detail below. For example, one or more gripping ridges 48 may be formed on the outer portion 44a, 44b of the respective locking tab 40a, 40b. The outer portions 44a, 44b are not limited to a particular size, shape and/or configuration, so long as the outer portions 44a, 44b permit the functionality described herein.

Referring again to FIG. 3, an opposing inner portion 46a, 46b of each locking tab 40a, 40b extends laterally inwardly beyond an interior surface of the shield 20. As shown in FIGS. 4 and 5, the inner portion 46a, 46b of each locking tab 40a, 40b provides a surface or structure to at least temporarily engage at least a portion of the respective projection 34a, 34b and/or groove 30a, 30b, so as to selectively hold and/or lock the fixed portion 22 of the shield 20 to the base 12, as described in detail below. More specifically, at least one depression 50a, 50b may be formed in a top surface of the inner portion 46a, 46b of each locking tab 40a, 40b, respectively. Each depression 50a, 50b is sized and shaped to receive at least a portion of the respective projection 34a, 34b, which holds and/or locks the respective locking tab 40a, 40b in place in a detent-type fashion. Each groove 30a, 30b may include two or more projections 34a, 34b, and each locking tab 40a, 40b may include two or more depressions 50a, 50b.

As shown in FIGS. 4 and 5, one or more spring arms 52a, 52b may be formed on the top surface of the inner portion 46a, 46b of each locking tab 40a, 40b. Each spring arm 52a, 52b may be aligned with one of the depressions 50a, 50b, respectively. The spring arms 52a, 52b assist in maintaining the locking tab 40a, 40b within the respective slot 42a, 42b by engaging at least a portion of the fixed portion 22 of the shield 20. Thus, the spring arms 52a, 52b assist in attaching the locking tabs 40a, 40b to the fixed portion 22 of the shield 20.

Referring to FIGS. 3-5, each locking tab 40a, 40b is movable with respect to the shield and within the respective slot 42a, 42b. In particular, the locking tabs 40a, 40b are slidable between a first, forward or unlocked position (see FIGS. 1, 3 and 4) and a second, rearward or locked position (see FIGS. 3 and 5). In the first position (FIGS. 3 and 4), the depression 50a, 50b of each locking tab 40a, 40b is spaced-apart from the respective projection 34a, 34b. In the first position, each locking tab 40a, 40b is preferably vertically aligned with a passageway 36a, 36b between the respective ledge 32a, 32b and a portion of the top wall 12a of the base 12, such that the locking tabs 40a, 40b can be lifted vertically upwardly and out of the respective groove 30a, 30b, so as to lift the shield 20 to separate the shield 20 from the base 12. In the second position (FIGS. 3 and 5), at least a portion of each locking tab 40a, 40b, such as the depression 50a, 50b, receives and/or engages at least a portion of the respective projection 34a, 34b to secure and/or lock the fixed portion 22 of the shield 22 to the base 12.

Stated differently, as each locking tab 40a, 40b is moved from the unlocked position to the locked position, the inner portion 46a, 46b acts as a cantilever arm or leaf spring that deflects downwardly during engagement with the respective projection 34a, 34b. Thus, the interference between the locking tab 40a, 40b and a portion of the groove 30a, 30b retains each locking mechanism 28a, 28b in the second, rearward or locked position (see FIGS. 3 and 5). The present disclosure is not limited to the inclusion of the projections 34a, 34b and the complementary depressions 50a, 50b. For example, the projections 34a, 34b and the depressions 50a, 50b may be omitted, such that moving the locking tabs 40a, 40b to the second position (FIGS. 3 and 5) may still prevent the shield 20 from being removed from the base 12 due to the interference between the ledge 32a, 32b and the respective inner portions 46a, 46b of the locking tabs 40a, 40b. In addition, the location and/or position of the projections 34a, 34b and the depressions 50a, 50b may be reversed without disrupting the above-described functionality.

In operation, when the locking tabs 40a, 40b are in the second or locked, a user may open or rotate the movable lid portion 24 of the shield 20 by simply using one hand to lift or rotate the movable lid portion 24, such as by grasping and raising the handle 25. During such movement, the locking mechanisms 20a, 20b counterbalance the moment or backward momentum of the movable lid portion 24 so that the fixed portion 22 of the shield 20 remains firmly and stably attached to the base 12. To remove the shield 20 from the base 12, the user, preferably with the movable lid portion 24 in the second, closed position, moves the locking tabs 40a, 40b from the second or locked position to the first or unlocked position. Then, the user preferably lifts the shield 20 vertically upwardly, so that the inner portions 46a, 46b of the locking tabs 40a, 40b pass through the passageway 36a, 36b of the respective groove 30a, 30b. The shield 20 can be attached and then locked in place by reversing the above-described operation. The user preferably operates the motor 14 with the movable lid portion 24 of the shield 20 in the second, closed position (FIG. 1)

It will be appreciated by those skilled in the art that changes could be made to the embodiments described above without departing from the broad inventive concept thereof. For example, the grooves 30a, 30b may be formed on or in the shield 20, and the locking tabs 40a, 40b may be formed on or in the base 12. It is understood, therefore, that this disclosure is not limited to the particular embodiments disclosed, but it is intended to cover modifications within the spirit and scope of the present disclosure as defined by the appended claims.

I claim:

1. A kitchen appliance comprising:
a base having a top wall and a motor positioned beneath the top wall;
a container removably mountable to the top wall of the base, at least a portion of the container being operatively engaged with the motor to prepare foodstuff therein;
a shield removably mountable onto the base to enclose the container; and
at least one locking mechanism to secure at least a portion of the shield to the base, the locking mechanism including:
a projection formed on or in one of the base and the shield; and
a locking tab attached to the other of the shield and the base, the locking tab being slidable between a first position and a second position, in the first position the locking tab being spaced-apart from the projection to allow the shield to be removed from the base, in the second position at least a portion of the locking tab engaging at least a portion of the projection to secure the shield to the base.

2. The kitchen appliance according to claim 1, wherein the shield includes a fixed portion attachable to the base and a movable lid portion pivotably attached to the fixed portion, the movable lid portion being pivotable between a first position and a second position, in the first position the movable lid portion exposing an interior of the shield, in the second position the movable lid portion enclosing the interior of the shield.

3. The kitchen appliance according to claim 2, wherein the locking tab is slidably attached to the fixed portion of the shield, the locking tab being slidable along an axis that extends generally perpendicularly to a longitudinal axis of the kitchen appliance.

4. The kitchen appliance according to claim 2, wherein the base includes a control panel proximate a front of the base, the movable lid portion being pivotable with respect to the fixed portion at an axis proximate a rear of the base, the projection and the locking tab being positioned proximate the front of the base.

5. The kitchen appliance according to claim 1, further comprising:
two spaced-apart locking mechanisms at opposing sides of the kitchen appliance, each locking mechanism including:
a projection formed in the base; and
a locking tab slidably attached to the shield, each locking tab being movable between the first position and the second position.

6. The kitchen appliance according to claim 1, wherein the locking tab includes an inner portion extending laterally inwardly beyond an interior surface of the shield and an opposing outer surface extending laterally outwardly beyond an exterior surface of the shield.

7. A kitchen appliance comprising:
a base having a top wall and a motor positioned beneath the top wall;
a container removably mountable to the top wall of the base, at least a portion of the container being operatively engaged with the motor to prepare foodstuff therein;
a shield removably mountable onto the base to enclose the container; and
at least one locking mechanism to secure at least a portion of the shield to the base, the locking mechanism including:
a groove formed on or in one of the base and the shield; and
a locking tab attached to the other of the shield and the base, the locking tab being movable between a first position and a second position, in the first position at least a portion of the locking tab being aligned with a passageway of the groove to allow the shield to be removed from the base, in the second position at least a portion of the locking tab being spaced-apart from the passageway to secure the shield to the base.

8. The kitchen appliance according to claim 7, wherein a projection extends into the groove and the locking tab includes a depression, the depression being sized and shaped to receive at least a portion of the projection when the locking tab is in the second position.

9. The kitchen appliance according to claim 7, wherein in the second position at least a portion of the locking tab being aligned with a ledge the prevents the shield from being removed from the base.

10. The kitchen appliance according to claim 7, further comprising:
two spaced-apart locking mechanisms at opposing sides of the kitchen appliance, each locking mechanism including:
a groove formed in the base; and
a locking tab slidably to the shield.
